(19) United States
(12) Patent Application Publication
(10) Pub. No.: US 2010/0311284 A1
(43) Pub. Date: Dec. 9, 2010

(54) AIR GAP CONTACTOR

(75) Inventor: Yean Hong Tan, Bayan Lepas (MY)

Correspondence Address: CANTOR COLBURN LLP, 20 Church Street, 22nd Floor, Hartford, CT, 06103, US

(73) Assignee: KENSTRONICS (M) SDN BHD, BAYAN LEPAS (MY)

(21) Appl. No.: 12/746,681

(22) PCT Filed: Dec. 5, 2008
(86) PCT No.: PCT/MY08/00178

§ 371 Date: Aug. 25, 2010

(30) Foreign Application Priority Data
Dec. 6, 2007 (MY) PI20072177

(51) Int. Cl. H01R 13/15

(52) U.S. Cl. 439/786

(57) ABSTRACT

A contactor having an internal air gap (5a, 5b) which provides the lowest dielectric constant is provided to be capable of improving signal integrity electrical performance of a test contactor. Resultantly, the present invention reduces the possibilities of impedance mismatch during signal transmission thereby improving insertion loss and return loss of the signal pins.

### TECHNICAL FIELD

Devices are provided for testing electronic components and, more specifically, a contactor device is provided having a plurality of internal air gaps to improve the signal integrity electrical performance of a test contactor.

### BACKGROUND

A conventional contactor usually contains a plurality of spring probes and therefore, these types of contactors are referred to as spring probe pins contactors. Double ended spring probe pins, hereinafter referred to as spring probe pins which are well known in the art, and they typically provide a shaft with a compressible portion at both ends of the shaft. Thus, when a plurality of spring probes located within a contactor are compressed by the insertion of a plurality of pins onto the contactor or by other contact elements such as C4 solder balls, these spring probes provide electrical contact between each of the pins or contact elements and the different electrical contact pins on the DUT board.

A problem of major concern with this approach has been inferior signal integrity (SI) electrical performance causing a distortion of the signal waveforms in the signal path and a resultant loss of impedance control or electrical continuity.

Impedance control is a major contributor in determining the performance of the test contactor. Among the factors that contribute to the impedance of a signal pin in a test contactor are dielectric constant of the contactor material, pitch, and diameter of the probe pin. These factors exist on current test contactor designs.

Generally, the SI electrical performance of a test contactor is defined as the speed and quality of the signal transmitted and received via probe pins in the test contactor from the tester to the IC package and back to the tester again. These probe pins are further separated as power, ground and signal pins. There are multiple variables that contribute to this electrical performance of the test contactors. An example is the mechanical variable of the probe pin's pitch, diameter and length.

A conventional test contactor consists of two plates made of engineered plastic materials. Each plate serves the purpose of housing and locating the probe pins. The main challenge of optimizing the electrical performance or SI of a test contactor is to have a good control in the signal path impedance. This is achieved by selecting materials with suitable dielectric constant.

Therefore there exists a need to provide an avenue for improved electrical performance/SI of a test contactor.

### BRIEF SUMMARY

The disclosure provides a new feature known as an internal air gap to further improve the control over loss impedance control. By providing an air gap internally in the test contactor the effective dielectric constant is further improved. This is because the air gap created provides the lowest dielectric constant possible and the best dielectric loss tangent value achievable thus further improves the signal integrity of the contactor. When enhanced it achieves an optimized electrical performance of which these enhancements are done by abiding on the premise of the SI theory.

An improved contactor is provided that facilitates good impedance control and to improve the SI electrical performance of a contactor.

In accordance with one embodiment, the device comprises at least a six piece construction.

The contactor provides a first contact means (top probe pins), second contact means (bottom probe pins) which extend above and below the surface of the said first and second contact means respectively to make contact with the DUT; a top plate, bottom plate which serve as the housing to hold and for locating features for the probe pins and a recessed portion forming top internal air gap and bottom internal air gap.

The top internal air gap and bottom internal air gap are formed by removing some parts of the contactor's material in order to have a better dielectric constant of which the air gap has a dielectric constant of 1, also known as the dielectric constant of air. Considering the fact when the impedance are way below the required impedance, by reducing the dielectric constant this helps in increasing the impedance of the probe pin as the impedance is inversely proportional to the dielectric constant.

By realigning the design to have closer effective impedance to the required impedance, the said device is eventually reducing the effect of impedance mismatch which mostly contributes to the downgrading of the contactor signal integrity as the signals cross the mismatched boundary. Impedance mismatch mainly determines how many reflections happen when the signals travel through different topology or medium. Therefore, the introduction of air gap notions will improve the performance of return loss which is an important measure of power reflected from imperfections in an electrical link.

Apart from the above, when the air gap is created thus removing the materials also means altering the effective dielectric loss tangent along the signal pins. Air, having the lowest dielectric loss tangent value would effectively improve the losses incurred during insertion and signal transmissions. The Electrical Properties of air provides the best dielectric loss tangent value of zero that could not be achieved in any materials. The other advantage of the said device is that it has better insertion loss performance as opposed to conventional contactors which consist only of solid top plate and bottom plate.

This description is provided by way of example only and it is to be noted and appreciated of the fact that to all intents and purpose of the present invention, the important factors such as the required height, length, size and other forms and shapes are determined in accordance to the present embodiment of the present invention obtain the necessary impedance and thus maximizing the signal integrity of the contactor.

The foregoing and other features and advantages of the invention will be apparent from the following, more particular, description of the preferred embodiments of the invention, as illustrated in the accompanying drawings.

### BRIEF DESCRIPTION OF THE DRAWINGS

FIG. 1 shows the conventional construction of a probe pin contactor. (Prior Art)

FIG. 2 shows the front view of the interface structures in accordance with the present invention

FIG. 3 shows the top view of the contactor

FIG. 4 shows the isometric view of the contactor

### DETAILED DESCRIPTION

While the making and using of various embodiments of the present invention are discussed in detail below, it should be appreciated that the present invention provides for inventive concepts capable of being embodied in a variety of specific contexts. The specific embodiments discussed herein are merely illustrative of specific manners in which to make and use the invention and are not to be interpreted as limiting the scope of the present invention.

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

Turning now to the specific illustration of the present invention with references made to the figures appended herein.

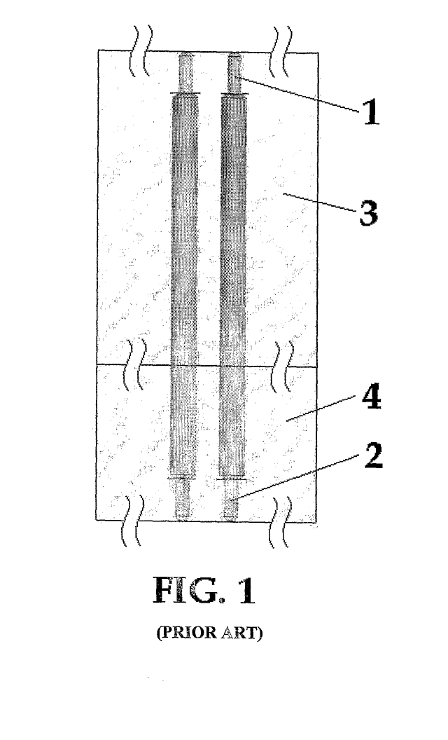

With reference to its orientation in FIG. 1, the conventional design for a probe pins contactor for semiconductor device testing conventionally include four main parts: top probe pin (1), bottom probe pin (2), top plate (3), bottom plate (5). The said plates serve as the housing and for locating features for the probe pins.

To all intents and purposes of and within the scope of the present invention, probe pins may either be of double ended or single ended.

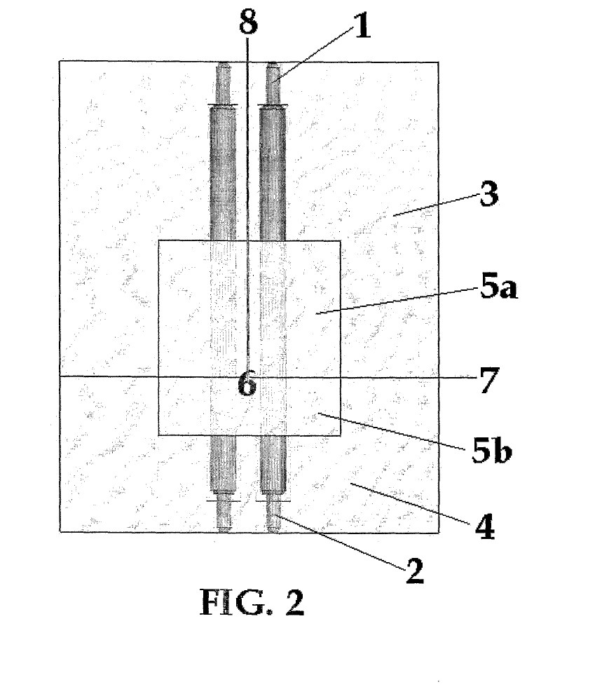

The contactor in accordance with an exemplary embodiment of the present invention is illustrated in FIG. 2. FIG. 2 illustrates one embodiment of the present invention from front view (Refer the X-axis (6) where Z-axis (8) is at the top and Y-axis (7) is on the right). The present invention in accordance with FIG. 2 has six major components; first contact means (1), second contact means (2) wherein said first contact means (1), second contact means (2) for being moved into a disposition of electrical continuity with said first contact means; top plate (3), bottom plate (4) wherein said top plate and bottom plate (3,4) are joined by a pair of opposing side walls for housing and locating features of probe pins.

The present invention also comprises a recessed portion (5) which forms a cavity. Within the cavity are a plurality of air gap (5a, 5b) of which when some parts of the contactor's material are removed, said air gaps (5a, 5b) increases the inductive impedance of the contactor and to achieve a more effective dielectric constant to 1, whereby the standard dielectric constant of air is 1.

Considering the fact when the impedance are way below the required impedance, by reducing the dielectric constant, these air gaps (5a, 5b), helps in increasing the impedance of the probe pins (1,2) as the impedance is inversely proportional to the dielectric constant.

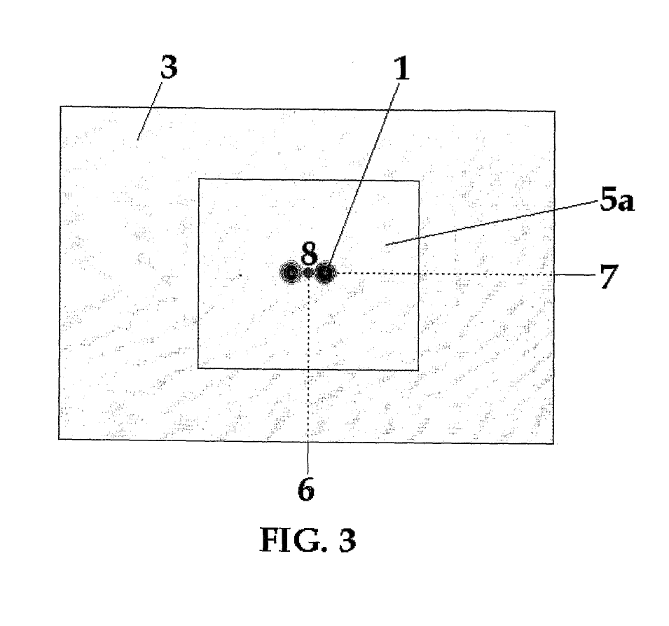

FIG. 3 illustrates the top view of the said air gap contactor (Refer the Z-axis (8) of the design, where X-axis (6) is at the bottom and Y-axis (7) is on the right). The length, the width, and the height of the air gap (5a) are determined according to the electrical requirements. Resultantly, when the air gap (5a) is created, some materials from top plate (3) are removed which facilitates the altering the effective dielectric loss tangent along the probe pins (1). Air, having the lowest dielectric loss tangent value, thus improves the losses incurred during insertion and signal transmissions.

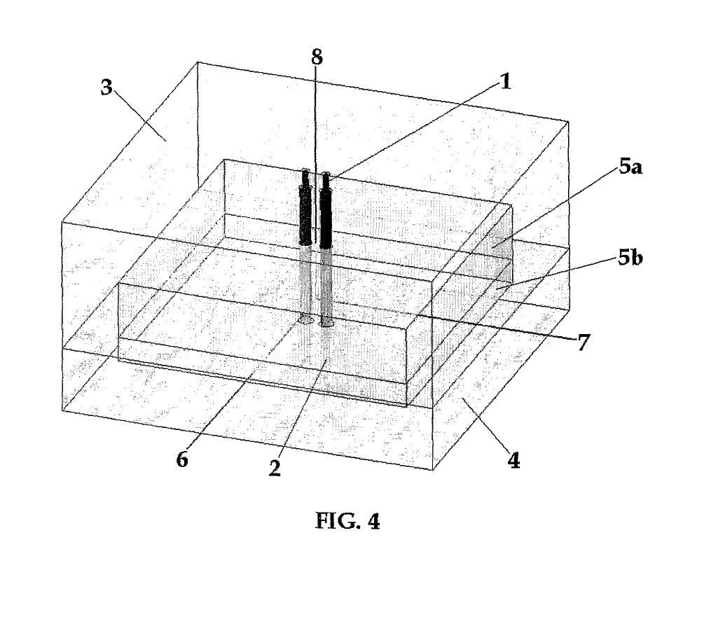

FIG. 4 illustrates the isometric view of the said invention of the Air Gap Contactor (where the Z-axis (8), X-axis (6), and Y-axis (7) are shown). This clearly shows that the length, width, and height of the air gap (5a, 5b) can be designed and simulated, in order to maximize the electrical performance of the air gap contactor, to obtain the necessary impedance and have the maximum signal transfer.

Another embodiment which is not shown in the figures and should be appreciated is that the substrate contactor comprises of movable armature means which is mechanically interconnected with said first and second contact means (1,2) for moving said contact means into disposition of electrical continuity in response to the flow of electrical current.

As can be realized each part may be separately fabricated with accurate dimensions to facilitate the assembly. The assembly and maintenance of the contractor clearly has numerous variations that are possible such as height, length, size, shapes and forms that do not depart from the spirit and scope of the inventive principles. Accordingly, limitations should be imposed only in conformance to the appended claims and their equivalents.

1. A contactor for electrically connecting terminals of an electronic part to an external circuit having top probe pin, bottom probe pin, substrate engaging member, top plate, and bottom plate wherein the contactor comprises:
a first contact means;
second contact means for being moved into a disposition of electrical continuity with said first contact means;
movable armature means which is mechanically interconnected with said second contact means for moving said second contact means into said disposition of electrical continuity with said first contact means in response to a flow of electrical current; and a top plate and a bottom plate.

2. A contactor according claim 1, further comprising a recessed portion which forms a cavity.

3. A contactor according to claim 2, wherein within said cavity comprises a plurality of internal air gaps.

4. A contactor according to claim 2, wherein said contactor may be a single or double ended probe pin.
